(19) United States
(12) Patent Application Publication
(10) Pub. No.: US 2021/0157107 A1
(43) Pub. Date: May 27, 2021

(54) FOLDED TELESCOPIC LENS SYSTEM

(71) Applicant: SPECTRUM OPTIX INC., Calgary (CA)

(72) Inventor: Clark Pentico, Ukiah, CA (US)

(21) Appl. No.: 17/103,542

(22) Filed: Nov. 24, 2020

Related U.S. Application Data
(60) Provisional application No. 62/941,372, filed on Nov. 27, 2019.

(51) Int. Cl. G02B 13/00

(52) U.S. Cl. CPC G02B 13/0065; G02B 13/002

(57) ABSTRACT

A folding lens system includes: one or more objective lenses for receiving a light path from an object along a first optical path; a beam steering device for redirecting the light path along a second optical path at an angle α to the first optical path; and two or more focusing lenses disposed in the second optical path for focusing the reflected light path on an image plane, the two or more focusing lenses include a positive-powered lens, and one or more negative-powered lenses disposed between the positive-powered lens and the image plane.

### CROSS-REFERENCE TO RELATED APPLICATIONS

This patent application claims the benefits of U.S. Provisional Patent Application Ser. No. 62/941,372, filed on Nov. 27, 2019, and entitled “Folded Telescopic Lens System,” the entire content of which is hereby expressly incorporated by reference.

### FIELD OF THE INVENTION

The disclosed invention generally relates to optical lenses and more specifically to a folded telescopic lens system.

### BACKGROUND

Imaging devices such as cameras, microscopes and telescopes are heavy and large. A large portion of this weight is due to the design of the optical lens elements, which include heavy curved lenses, and the structure to support these lenses separated by long and bulky focal distances. These imaging devices are large, mainly because in a typical lens system, the opening aperture to system depth ratio is small. Moreover, to optically improve image resolution with the traditional lens systems, more depth is required in order to reduce lens refraction and minimize lens aberrations. This can set limitations on the imaging systems' performance and design, particularly with mobile devices (e.g., smart phones), and lens systems with a long focal length, and narrow field of view.

The proliferation of compact, mobile camera devices such as smartphones and tablet devices has resulted in a need for higher magnification, high-resolution camera devices with a compact form factor. However, due to packaging constraints of standard mobile camera device technology, these devices tend to capture wide field-of-view images with limited magnification. Achieving higher magnification images in a compact form factor has been limited by photo-sensor size and lens geometry. As camera technology advances there is a demand for compact imaging lens system with improved image quality and higher magnifications for long range viewing.

### SUMMARY

In some embodiments, a folding lens system includes: one or more objective lenses for receiving a light path from an object along a first optical path; a beam steering device for redirecting the light path along a second optical path at an angle α to the first optical path; and two or more focusing lenses disposed in the second optical path for focusing the reflected light path on an image plane, wherein the two or more focusing lenses include a positive-powered lens, and one or more negative-powered lenses disposed between the positive-powered lens and the image plane.

In some embodiments, at least one of the one or more objective lenses includes low dispersion material to reduce chromatic aberration. In some embodiments, the beam-steering device is a refractive element that changes the direction of the received light path in the folding lens system. The second optical path may be configured to change the angle α for tuning and calibration of the lens system. The positive-powered lens may comprise of a low-dispersion material and one or more negative-powered lenses are comprised of a high-dispersion material.

In some embodiments, the positive-powered lens may be stationary relative to the folded lens system, and the one or more negative-powered lenses may be movable relative to the positive-powered lens for focusing. The folding lens system may be positioned within or attachable to a display of a phone or a camera to display the image of the object. The one or more objective lenses may include an aspheric lens element and the two or more focusing lenses may include at least one aspheric lens

### BRIEF DESCRIPTION OF THE DRAWINGS

A more complete appreciation of the disclosed invention, and many of the attendant features and aspects thereof, will become more readily apparent as the disclosed invention becomes better understood by reference to the following detailed description when considered in conjunction with the accompanying drawings in which like reference symbols indicate like components.

FIG. 1 is a diagram of a folded telescopic lens system, according to some embodiments of the disclosed invention.

FIG. 2 illustrates an exemplary focusing mechanism, according to some embodiments of the disclosed invention.

FIG. 3 shows a plot of Modulation Transfer Function (MTF) versus a spatial frequency in cycles per millimeter, according to some embodiments of the disclosed invention.

### DETAILED DESCRIPTION

Embodiments of the present invention are directed to a folding lens system, for example, for a compact camera to obtain a high-quality image with a more compact optical lens system. In some embodiments, the folded lens system includes one or more objective lenses with refractive power, a light path folding element and one or more focusing lenses. Light enters the camera through lenses on a first optical path or axis is refracted to the folding element, which redirects the light to a second optical axis with lenses that focus the light to form an image at a photo-sensor plane. At least one of the lenses is made of low dispersion material to improve color correction of the image. Materials, radii of curvature, shapes, sizes, and spacing, of the optical elements may be selected to achieve quality optical performance and high image resolution in a compact form factor camera.

In some embodiments, the folded telescopic lens system according to the disclosed invention provides a light path to an image plane and may include one or more positive powered objective lenses, at least one of which includes low dispersion material. In addition, the lens system includes a beam-steering optics and a focusing lens group with at least one stationary lens and one moveable lens. In some embodiments, a sensor is positioned at the image plane behind the image plane to capture the image. In some embodiments, the sensor may be a camera film, a CCD sensor, a CMOS sensor or the like. In some embodiments, the folded telescope is positioned within or attachable to a display device, for example, the display device of a phone, tabled, or other mobile devices.

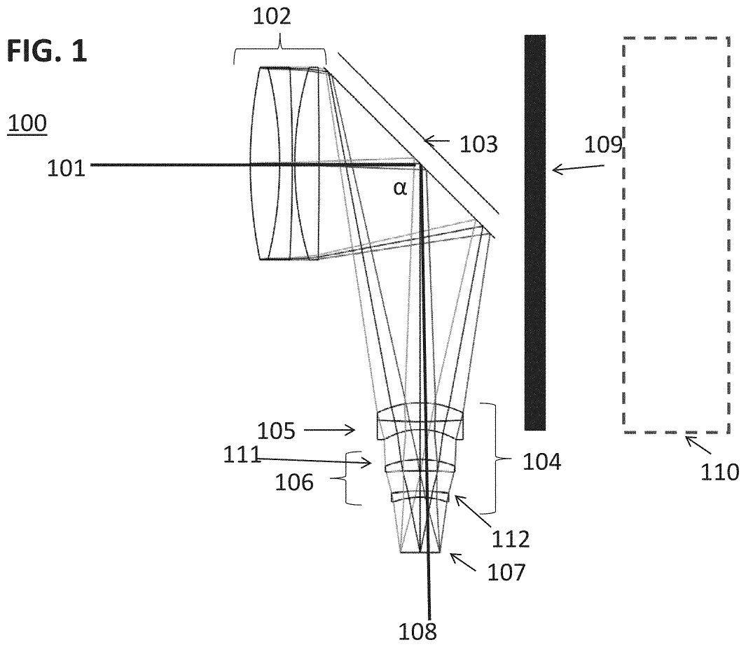

FIG. 1 shows a folded telescopic lens system, according to some embodiments of the disclosed invention. As shown, a light path from an object (not shown) enters one or more objective lenses 102 along a first optical path 101 and is redirected (folded) by a beam-steering device 103 along a second optical path 108 at an angle α to the first optical path 101. The reflected light along the second optical path 108 is focused on an image plane 107 by one or more focusing lenses 104. In some embodiments, at least one of the one or more objective lenses 102 includes low dispersion material, for example, low dispersion glass or plastic. Low-dispersion materials (e.g., glass or plastic) are used to reduce chromatic aberration, which are caused by a failure of a lens to focus all colors to the same point.

In some embodiments, the beam-steering device 103 is a reflective object 103 that changes the direction the beam is transmitted. In some embodiments, beam steering device 103 is or uses mirrors, prisms, or lenses to perform beam-steering. This way, the folding angle α, which is the angle between the first optical path and the second optical path, may be easily changed for tuning and calibration of the lens system. The beam-steering could be used to pan or tilt of the lens mechanism.

In some embodiments, the one or more focusing lenses 104 include a positive-powered lens 105 and one or more negative-powered lens 107. As known in the art, a positive-powered lens may be biconvex, convex-concave, plano-convex or a combination of more than one lenses, where a collimated beam of light passing through the lens converges (focuses) to a spot behind the lens. A negative-powered lens may be a biconcave, plano-concave lens or concave-convex or a combination of more than one lens, where a collimated beam of light passing through the lens is diverged or spread coming out of the lens. As a result, the light beam will focus to a particular point on the axis at the image plane 107, after passing through the lens. The combination of the positive-powered lens 105 and the negative-powered lens(es) 106, ensure an optimum image quality for a telescopic lens for an object to be viewed or imaged located at various distances, while maintaining a good image quality.

In some embodiments, the positive-powered lens 105 is made of a low-dispersion glass/plastic, while the negative-powered lens 106 is made from a high-dispersion glass/plastic. To counteract the effect of the negative lens, the positive-powered lens is typically more powerful than the negative-powered lens. Achromatic doublets therefore have higher thickness and weight than the equivalent non-chromatic-corrected single lenses.

In some embodiments, the beam steering device 103 is one or more mirrors. In these folded lens systems, the magnification of the image is increased by reducing the field of view. High magnification images typically have a narrow field of view (for example, 5 degrees or less), which can limit the practical use of these lens system to long focal length applications. Because the imaging system has a relatively large aperture size with lots of light, images can be captured very quickly.

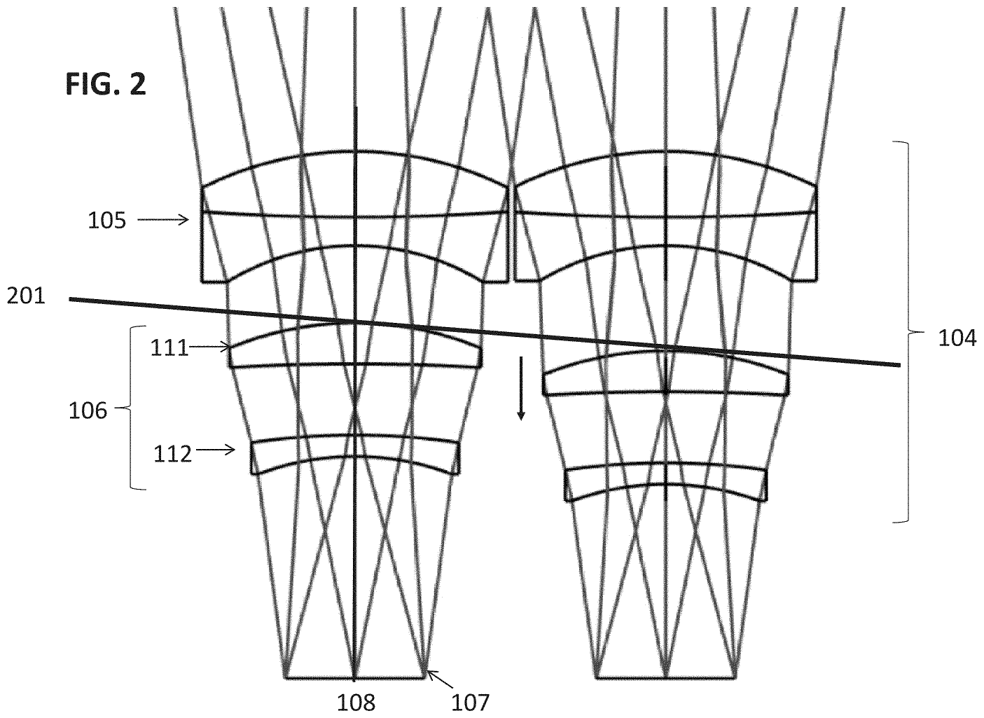

FIG. 2 illustrates an exemplary focusing mechanism, according to some embodiments of the disclosed invention. In some embodiments, the positive-powered lens 105 is fixed (stationary) relative to the folded lens system, while the negative-powered lens 106 is movable relative to the positive-powered lens 105 for focusing purposes, as depicted in FIG. 2. For example, for an infinity focus, the negative-powered lens 106 is at the closest distance from the positive-powered lens 105. As the focusing distance decreases from the infinity, the negative-powered lens 106 gets farther from the positive-powered lens 105 to perform focusing for closer objects to the lens system.

As depicted, the line 201 shows the change in focus locations of the relevant lenses. For example, for the left side, the focus is at infinity and for the right side the focus is at 10 meters. The arrow shows the direction of motion for the lens group 106.

In some embodiments, a processor, such as an image processor, may receive image information from the image sensor and modify/enhance this information, as required by the application of the folded lens. The processor may be part of a mobile device that includes a camera that contain the folded telescopic lens system, and may include all of the features of a smart mobile device, such as a smart phone or tablet for processing, enhancing and manipulating the images.

In some embodiments, the objective lens 102 is a positive-powered lens. In some embodiments, the objective lens 102 is an aspheric lens element. In some embodiments, the focusing lens group 104 contains at least one aspheric lens element. For example, lens 111 may be an aspheric lens element. The aspheric surface profile of an aspheric lens element can reduce or eliminate aberrations, such as spherical, coma or astigmatism, compared to a simple lens.

The folded telescopic lens system may be positioned within or attachable to a display 109 device of, for example a phone or camera 110 to display the image of the object being viewed.

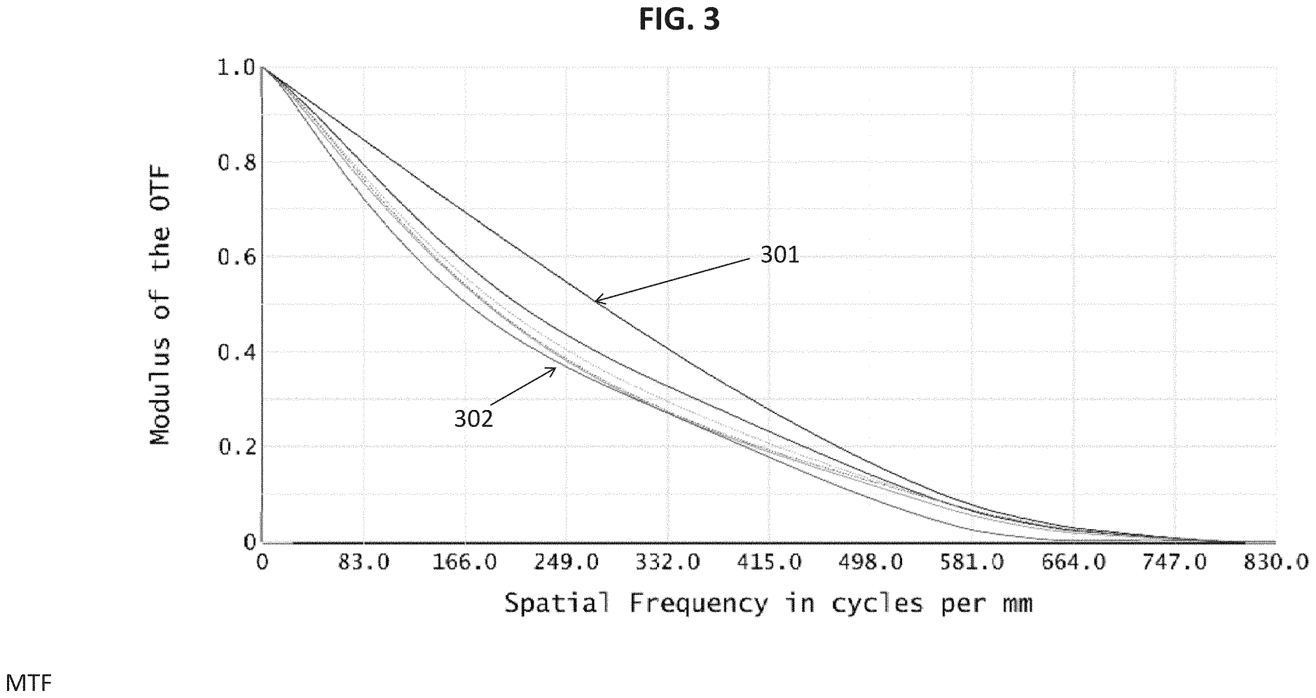

FIG. 3 shows a plot of Modulation Transfer Function (MTF) versus a spatial frequency in cycles per millimeter, according to some embodiments of the disclosed invention. In some embodiments, diffraction limited optical imaging performance can be achieved. This can be measure in the form of Modulation Transfer Function (MTF), spot size, ray aberrations and other methods known in the art. The MTF is a measure of the image quality of the lens. The diffraction limited line 301 is the theoretical best image quality that can be achieved based on the fundamental limits of light for a given lens. The measure of the lens performance 302, (below the diffraction limit) indicate the performance of this lens is near the diffraction limited that are predicted by physics.

It will be recognized by those skilled in the art that various modifications may be made to the illustrated and other embodiments of the invention described above, without departing from the broad inventive scope thereof. It will be understood therefore that the invention is not limited to the particular embodiments or arrangements disclosed, but is rather intended to cover any changes, adaptations or modifications which are within the scope of the invention as defined by the appended claims and drawings.

What is claimed is:

1. A folding lens system comprising:
one or more objective lenses for receiving a light path from an object along a first optical path;
a beam steering device for redirecting the light path along a second optical path at an angle α to the first optical path; and
two or more focusing lenses disposed in the second optical path for focusing the reflected light path on an image plane, wherein the two or more focusing lenses include a positive-powered lens, and one or more negative-powered lenses disposed between the positive-powered lens and the image plane.

2. The folding lens system of claim 1, wherein at least one of the one or more objective lenses includes low dispersion material to reduce chromatic aberration.

3. The folding lens system of claim 1, wherein the beam-steering device is a refractive element that changes the direction of the received light path in the folding lens system.

4. The folding lens system of claim 3, wherein the reflective object is a mirror or prism.

5. The folding lens system of claim 1, wherein the second optical path is configured to change the angle α for tuning and calibration of the lens system

6. The folding lens system of claim 1, wherein the positive-powered lens is comprised of a low-dispersion material the one or more negative-powered lenses are comprised of a high-dispersion material.

7. The folding lens system of claim 6, wherein the positive-powered lens is more powerful than the one or more negative-powered lenses.

8. The folding lens system of claim 1, wherein the positive-powered lens is stationary relative to the folded lens system, and the one or more negative-powered lenses are movable relative to the positive-powered lens for focusing.

9. The folding lens system of claim 8, wherein as a focusing distance increases from infinity, the one or more negative-powered lenses are farther to the positive-powered lens to perform focusing for closer objects.

10. The folding lens system of claim 1, positioned within or attachable to a display to display the image of the object.

11. The folding lens system of claim 10, wherein the display is a display of a phone or a camera.

12. The folding lens system of claim 1, wherein the one or more objective lenses include an aspheric lens element.

13. The folding lens system of claim 1, wherein the two or more focusing lenses include at least one aspheric lens.
